(19) United States
(12) Patent Application Publication
(10) Pub. No.: US 2022/0106178 A1
(43) Pub. Date: Apr. 7, 2022

(54) LINE FOR PREPARING AND FILLING BOTTLES

(71) Applicant: SYNERLINK, PUISEUX PONTOISE (FR)

(72) Inventors: Loïc MAUBOUSSIN, PUISEUX PONTOISE (FR); Luc VIEULOUP, PUISEUX PONTOISE (FR)

(21) Appl. No.: 17/419,134

(22) PCT Filed: Dec. 27, 2019
(86) PCT No.: PCT/FR2019/053310

§ 371 Date: Jun. 28, 2021

(30) Foreign Application Priority Data
Dec. 28, 2018 (FR) 18 74336

(51) Int. Cl. B67C 7/00; B65G 47/86; B65G 47/51; B67C 3/24; B29C 49/42

(52) U.S. Cl. CPC B67C 7/002; B65G 47/842; B65G 47/5113; B67C 2003/227; B29C 49/4273; B29C 49/421; B65G 2201/0247; B67C 3/242

(57) ABSTRACT

Facility for the production of bottles of liquid products, the bottles being formed from thermoformable plastic, the facility including a blowing device for blowing bottles from preforms, with a heating tunnel, a filling and finishing line including bottle filling, sealing, and/or capping stations, with a buffer conveyor interposed between the blowing device and the filling and finishing line, formed mainly as an endless conveyor suitable for receiving bottles, the buffer conveyor including a first section used under normal flow conditions, and a second section complementary to the first section and serving as buffer storage space under conditions of unplanned stoppage of the filling line, the bottle storage capacity of the second section being at least equal to the number of bottles and preforms which can be received in the blowing machine including in the heating tunnel.

### CROSS-REFERENCE TO RELATED APPLICATIONS

This application is the U.S. national phase of International Application No. PCT/FR2019/053310 filed Dec. 27, 2019 which designated the U.S. and claims priority to FR 18 74336 filed Dec. 28, 2018, the entire contents of each of which are hereby incorporated by reference.

### BACKGROUND OF THE INVENTION

### Field of the Invention

The invention relates to a line for preparing and filling bottles. In particular, it relates to bottles made of thermoformable plastic, intended to be filled with liquid. The liquid in question may be a food product or a pharmaceutical product, without excluding other products such as care products, cleaning products, etc.

### Description of the Related Art

We are interested in the case of a production line which comprises both a device for forming thermoformable plastic bottles and a bottle filling line arranged downstream from the blowing. In the jargon of the trade, this is called “combined blowing and filling”.

The inventors have sought to improve the situation which can arise when the filling line is stopped in an unplanned manner, in which case the bottle preforms that are within the blowing device are no longer usable and must be scrapped.

Document WO2013/080189 teaches the principle of using a buffer storage between the bottle forming device and the filling line in order to make the operation of each of the machines more independent and to tolerate a momentary shutdown of one of the machines without necessarily interrupting the other machine.

However, it turns out that the known buffer storage devices are bulky and expensive. The object of the present invention is to provide an improved solution.

### SUMMARY OF THE INVENTION

To this end, a facility for the production of bottles of liquid or semi-liquid products is proposed according to a first aspect, the bottles being formed from thermoformable plastic, the facility comprising:

a blowing device (1) for blowing bottles from preforms (9), with a heating tunnel (8),

a filling and finishing line (3), comprising one or more bottle filling, sealing, and/or capping stations, the line comprising an endless conveyor receiving empty bottles (7) ready to be filled and conveying the bottles in front of several filling, sealing, and/or capping stations, characterized in that a buffer conveyor (2) interposed between the blowing device and the filling and finishing line is provided, formed mainly as an endless conveyor, the buffer conveyor comprising a first section (T21) used in normal flow conditions, and a second section (T22) complementary to the first section and serving as a buffer storage space under conditions of unplanned stoppage of the filling line, with an upstream handling device interposed between the blowing device and the buffer conveyor, having a number N4 of locations for bottles,

and in that the bottle storage capacity of the second section T22, denoted N22, is dimensioned to satisfy the condition N22>N8+N1−N4−1, where

N8 designates the number of bottles and preforms that can be received in the heating tunnel and N1 designates the number of bottles and preforms that can be received in the blowing device.

With these arrangements, if the filling line stops for any reason, then the buffer conveyor advantageously continues to accept the arrival of empty bottles from the blowing device and to accumulate them in its second section. The blowing device can thus continue to operate normally and the preforms which were located within the heating tunnel can be blown and stored in the buffer conveyor while waiting for the filling line to restart. This advantageously avoids having to scrap pieces.

From another perspective, when the filling line is operating normally, i.e. under normal flow conditions, the buffer conveyor functions as a transfer conveyor on its first section T21 without using the second section which then remains empty, advancing but without any bottles; whereas conversely, if the filling line stops, the buffer conveyor switches to storage operation, meaning that the bottles accumulate inside the second section while passing through the first section.

As soon as the filling line is back in operation, then the bottles in the buffer conveyor can be emptied in FIFO mode (first in first out) while the blowing device is returned to operation.

In addition, the proposed device has good compactness and does not require a complex control system.

The term “endless conveyor” is to be understood here to mean a conveyor in the form of a loop closed on itself.

It should be noted that the number N4 of bottle locations available in the upstream handling device may be zero, or may be equal to a predefined integer value, for example between 1 and 20.

In various embodiments of the invention, one or more of the following arrangements, individually or in combination, may optionally also be used.

According to one option, the buffer conveyor operates with indexed kinematics, meaning with stationary operation after advancement. In other words, for a given bottle, it operates in step-by-step mode, with a succession of stationary operations and transfer operations. This facilitates the loading and unloading of the buffer conveyor.

According to one option, the bottle blowing device operates with indexed kinematics, meaning with stationary operation after advancement. The blowing process, for a given bottle, is carried out in step-by-step mode, with a succession of stationary operations and transfer operations. As a result, the blow mold and its accessory equipment remain relatively simple.

According to one option, the bottle blowing device operates in batch production with batches of size N1, whether operating with indexed kinematics or continuous kinematics. As a result, high rates and significant productivity can be obtained.

According to one option, the filling and finishing line operates with indexed kinematics with stationary filling, preferably in batch production with batches of size N3. As a result, the filling process can remain fairly simple and well controlled with no parasitic effect from inertia or kinetics; similarly, indexed kinematics facilitate the possibilities of multi-filling, particularly in cases where several different products are to be dispensed into each bottle.

According to one option, in the context of a batch operation, the size of the batches and the cycle times of each of the machines are sized so that N1/T1 is close to N3/T3, preferably N1/T1 is substantially equal to N3/T3. T1 is the cycle time of the blow molding machine while T3 is the cycle time of the filling machine.

We note here that the cycle time of the buffer conveyor can be different from the other two cycle times T1 and T3.

According to one option, the upstream handling device comprises a first transfer device (4) for loading the bottles arriving from the blowing device onto the buffer conveyor (2). This first transfer device makes it possible for the handling means of the blow molding device to be substantially independent of the handling means formed by the buffer conveyor.

According to one option, a second transfer device (5) is provided for unloading the bottles from the buffer conveyor and loading them onto the filling and finishing line. This second transfer device makes it possible for the handling means formed by the buffer conveyor to be substantially independent of the handling means of the filling and finishing line. In particular, if for some reason the filling line stops, then the second transfer device becomes inactive (stopped) and the buffer conveyor can advantageously continue to accept the arrival of empty bottles from the blowing device (which then go past the second transfer device without transfer) in order to accumulate the empty bottles in the second section T22.

According to one option, the bottles are held by the neck, preferably exclusively by the neck, preferably the bottles are never placed on their bottom. Advantageously, the proposed process works with different volumes of bottles (e.g. 500 cl, 750 cl, 1 liter, 1.5 liters, without excluding other capacities). FIG. 4 illustrates this aspect.

According to one option, each bottle is held by a fork (6). This forms a simple and reliable device for holding a bottle by the neck (the throat). The fork can be configured to hold the bottle upright (mouth facing up) and upside down (mouth facing down). An elastic retaining means (clip or constriction) may be provided in the direction in which the bottles are loaded and unloaded on the fork. One will also note that the fork can hold the bottle in any spatial orientation.

According to one option, each bottle is held by a clamp. This solution makes it possible to accept different neck diameters in the same facility with the same handling means. Adjustment is easy: opening the clamp to a greater or lesser extent allows accepting necks of different diameters indiscriminately.

According to one option, it is provided that the forks can be grouped into sub-groups on a fork plate (66). This allows batch processing in the buffer conveyor, which can be advantageous in the case of batch processing upstream and downstream of the buffer storage.

According to one option, the buffer conveyor comprises a chain forming the support of the conveyor, and a plurality of forks, the forks being fixed on the chain, individually or in groups on a plate. Such a structure of conveyor with chain is a simple and reliable solution; this is a solution of controlled cost.

According to one option, the chain is mounted and wound on two or four wheels, said wheels having a horizontal axis of rotation; such a chain, generally arranged in a vertical plane, provides a compact solution with a small footprint.

According to one option, the filling and finishing line is formed as a conveyor moving plates equipped with one or more forks.

According to one option, also provided is a labeling and/or marking machine downstream of the filling machine; the labeling and/or marking stations allow the finishing touches to be applied to the products/bottles before final packaging and delivery.

According to one option, all or part of the facility can alternatively operate with continuous kinematics, for example the blowing can be with continuous kinematics and the rest with indexed kinematics. A facility operating entirely with continuous kinematics is also conceivable. Very high capacities can be obtained.

According to one option, the facility is configured for production at a rate of between 5,000 and 40,000 bottles per hour. Such a large capacity makes it possible to deliver contracts that are very large in volume.

According to one option, the cycle time of the blowing device T1 can be different from the cycle time of the filling line T3 (with a different number of pieces per batch).

In addition, according to a second aspect, a facility for the production of bottles of liquid or semi-liquid products is proposed, the bottles being formed of thermoformable plastic, the facility comprising:

a blowing device (1) for blowing bottles from preforms (9), with a heating tunnel (8),

a filling and finishing line (3), comprising one or more bottle filling, sealing, and/or capping stations, the line comprising an endless conveyor receiving empty bottles (7) ready to be filled and conveying the bottles in front of several filling, sealing, and/or capping stations, characterized in that a buffer conveyor (2) operatively arranged between the blowing device and the filling and finishing line is provided,

with an upstream handling device (145) interposed between the blowing device and the buffer conveyor, for loading and unloading bottles in the buffer conveyor, the buffer conveyor being formed mainly as an endless conveyor, the buffer conveyor serving as a buffer storage space under conditions of unplanned stoppage of the filling line,

and in that the bottle storage capacity of the buffer conveyor, denoted N2, is dimensioned to satisfy the condition N2>N8+N1−1, where

N8 designates the number of bottles and preforms that can be received in the heating tunnel and N1 designates the number of bottles and preforms that can be received in the blowing device.

Under normal operating conditions, the upstream handling device (145) loads the bottles coming from the blowing device (1) directly onto the filling line (3) without going through the buffer conveyor (2).

But, if for some reason the filling line stops, then the upstream handling device (145) is controlled to load the bottles coming from the blowing device into the buffer conveyor. The blowing device can thus continue to operate normally and the preforms which were located in the heating tunnel can be blown and stored in the buffer conveyor while waiting for the filling line to restart. This advantageously avoids having to scrap pieces.

As soon as the filling line is back in operation, then the bottles in the buffer conveyor can be emptied by the upstream handling device from the buffer conveyor to the filling line while the blowing device is returned to operation.

### BRIEF DESCRIPTION OF THE DRAWINGS

Other aspects, aims, and advantages of the invention will become apparent from reading the following description of an embodiment of the invention, given as a non-limiting example. The invention will also be better understood with regard to the accompanying drawings, in which:

FIG. 1 is a schematic representation of a line for preparing and filling bottles, as provided by the invention,

FIG. 2 is a schematic top view of the line for preparing and filling bottles of FIG. 1,

FIG. 3 shows more detail of the interface between a handling fork and the bottle neck in a top view,

FIG. 4 shows more detail of the interface between the handling fork and the bottle neck in a front view,

FIG. 5 shows a variant which allows handling two sizes of bottle neck,

FIG. 6 shows a variant using a multi-fork plate capable of holding several bottles at the same time, four in the example shown here,

FIG. 7 illustrates the first and/or the second transfer device, used to load or unload the bottles,

FIG. 8 illustrates an example of the buffer conveyor in its entirety,

FIGS. 9A, 9B, and 9C schematically represent the operation of the second section of the buffer conveyor,

FIG. 10 illustrates a top view of a second embodiment relating to a production line in continuous mode,

FIG. 11 shows a variant of the endless conveyor,

FIG. 12 shows a variant for holding the bottles, namely with clamps instead of forks,

FIG. 13 shows a third embodiment where the buffer conveyor is arranged in a parallel configuration, instead of a series configuration, for the flow of bottles.

### DESCRIPTION OF THE PREFERRED EMBODIMENTS

In the various figures, the same references designate identical or similar elements. For clarity in the presentation, certain elements are not necessarily represented to scale.

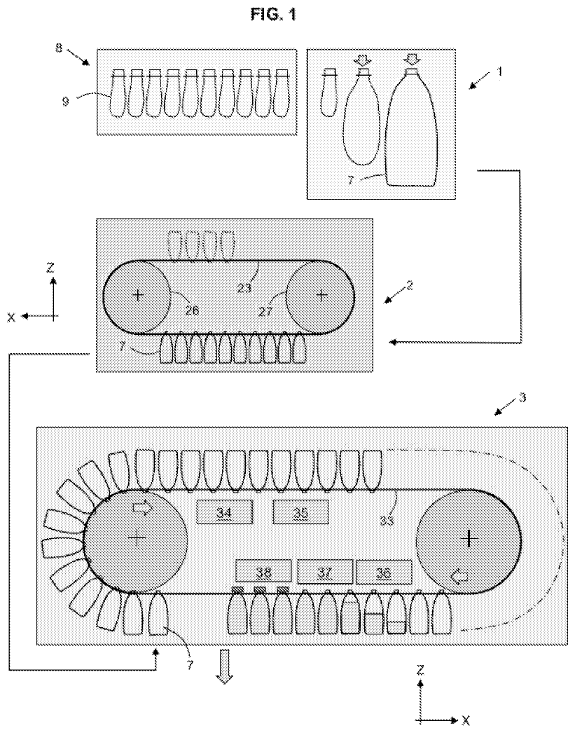

FIG. 1 schematically represents a facility for the production of bottles for liquid or semi-liquid products.

The bottles in question are formed of thermoformable plastic.

The term “bottle” is to be interpreted broadly here, and designates any container for liquid that is of various shapes: long bottles, short bottles, flasks, jars, mini-cubitainers, these containers being formed in particular of thermoformable plastic.

The material is PET (polyethylene terephthalate), but any other equivalent thermoformable plastic could also be used.

The bottles 7 are obtained from preforms 9. The finished bottle comprises a neck portion 7a and a body 7b.

Starting with the preforms, a blowing device 1 is used which is known per se and is therefore not described in detail here. The term blowing machine can also be used for blowing device. A heating tunnel 8 is provided upstream of the blowing device 1, so that the plastic material of the preforms is sufficiently malleable and thus allows easily blowing the preforms to make bottles 7. One will note that the neck portion 7a of each bottle is already formed as is in the preform, in other words it is the body 7b of the bottle which will be reshaped by blowing and not the neck which will remain unchanged by the blowing process.

N8 denotes the number of bottles and preforms that can be received in the heating tunnel 8. N1 denotes the number of bottles and preforms that can be received in the blowing device 1. N8 and N1 represent the number of locations for bottles or preforms, in other words the respective holding capacity of the heating tunnel and of the blowing device.

Downstream of the blowing process is installed a buffer conveyor 2, its operation and details to be explained below.

Downstream of the buffer conveyor 2 is installed a filling and finishing line denoted 3.

In the general arrangement, the buffer conveyor 2 is interposed between the blowing device 1 and the filling and finishing line 3.

The buffer conveyor 2 is formed mainly as an endless conveyor capable of receiving bottles.

The buffer conveyor comprising a first section T21 used under normal flow conditions, and a second section T22 serving as buffer storage space under conditions of unplanned stoppage of the filling line.

In the illustrated example, advantageously the second section T22 is complementary to the first section T21, in other words, placed end-to-end they form the entire endless conveyor.

The buffer conveyor comprises a chain 23 forming the movable support of the endless conveyor. Note that it is not excluded to use another solution to form the support of the conveyor, for example such as a reinforced composite belt.

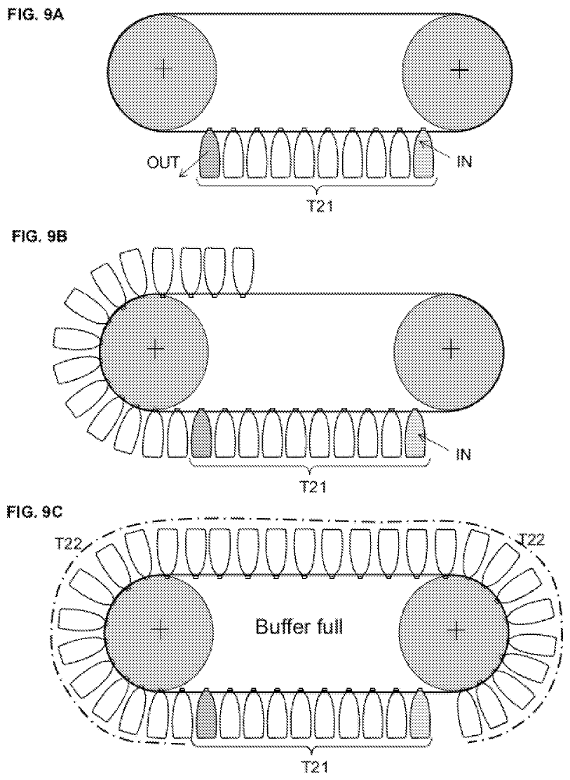

According to a first example (illustrated in FIGS. 1 and 9A-9C), the chain 23 is mounted and winds around two wheels 26,27, said wheels each having a horizontal axis of rotation Y6, Y7. One of the wheels is driven by an electric motor.

According to a second example (illustrated in FIGS. 8 and 11), the chain 23 is mounted and winds around four wheels 26-29, said wheels each having a horizontal axis of rotation (Y6-Y9). One of the wheels is driven by an electric motor and controlled in ad-hoc sequence by a programmable logic controller or more generally by a control unit.

The number of wheels is not necessarily limited to 3 or 4, and provision may be made for mounting a wheel on an axle provided with a preload intended to maintain a predetermined tensile stress throughout the length of the chain.

Referring to FIG. 1, the filling and finishing line 3 comprises one or more filling stations 36 (each optionally for a fraction of the filled volume), a sealing station 37, and a capping station 38.

Optionally, facing the upper segment of the endless conveyor of the filling line, a verification and/or blowing station 34 as well as a disinfection station 35 may be provided.

The filling and finishing line comprises a chain 33 forming the movable support of the endless conveyor. The filling and finishing line 3 is arranged along the endless conveyor, its general arrangement within a vertical plane XZ.

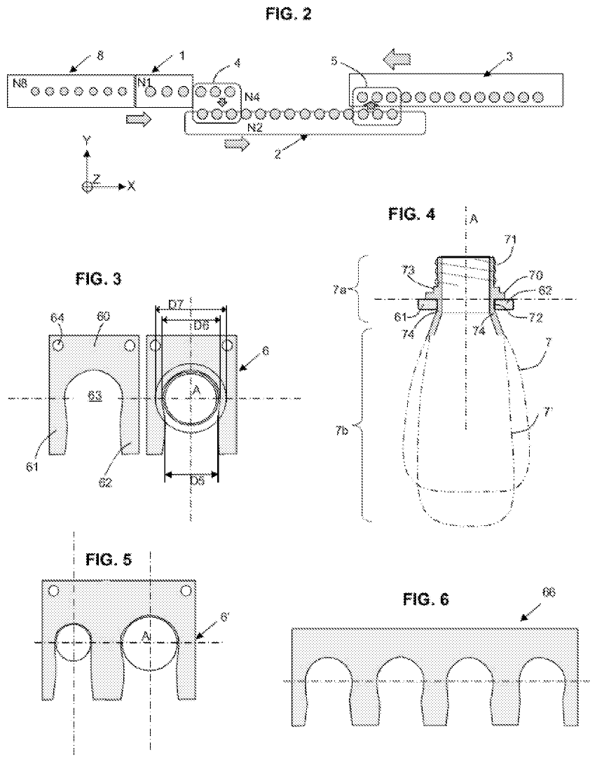

With reference to FIG. 2, at the outlet of the blowing device, an upstream handling device is provided. The number N4, defined as the number of bottle locations available in said upstream handling device, may be zero, or may be equal to a predetermined integer value, for example between 1 and 20.

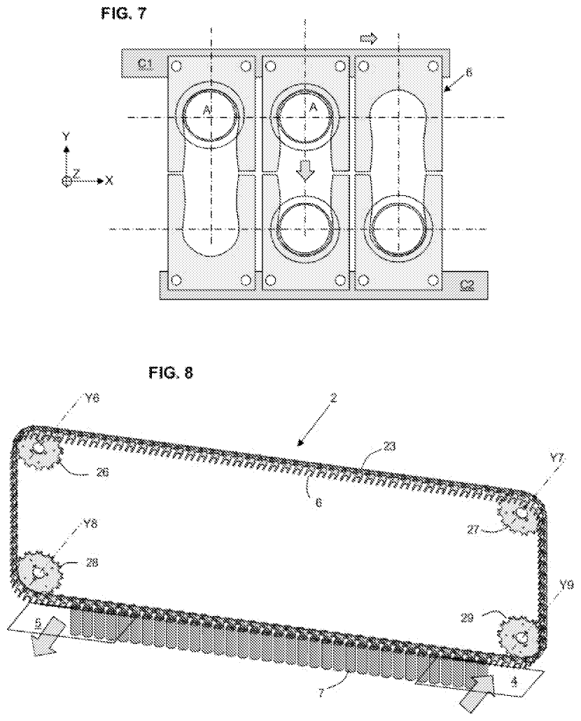

The upstream handling device comprises a first transfer device 4 for loading the bottles arriving from the blowing device onto the buffer conveyor 2. Several solutions are possible for such a transfer device; one particular solution will be illustrated in the commentary for FIG. 7.

Similarly, at the exit of the buffer conveyor, a second transfer device 5 is provided for unloading the bottles from the buffer conveyor and loading them onto the filling and finishing line 3. Here too, several solutions are possible for such a transfer device; one particular solution will be illustrated in the commentary for FIG. 7.

FIG. 3 illustrates a solution with individual forks as means for holding the bottles within the buffer conveyor. Note that this solution can be applied in a similar or identical manner in the conveyor of the filling and finishing line.

If we consider the shape of the bottle neck 7a in more detail, the neck portion comprises, viewed from the outside and from the upper free end:

an external thread 71 to receive a cap,

an annular support 73 to receive a safety ring or a tamper indicator ring,

a collar 70, formed as a flat ring, of larger diameter D7,

a throat 72 of diameter D6, D6 being substantially smaller than D7,

a flaring denoted 74, which forms the beginning of the body 7b of the bottle.

Note that the body of the bottle may have a general symmetry of revolution around the axis A. But the bottle may also have a body of generally square cross-section with rounded corners, in order to optimize the space occupied by packs of bottles.

The body of the bottle may have reinforcing ribs for crush resistance.

To adapt to such a geometry of the bottle neck, the facility advantageously provides for the use of forks, denoted 6.

As illustrated in FIG. 3, each fork comprises a base 60 and two fingers 61, 62 projecting from the base, the two fingers defining a receiving space/housing 63 to accommodate a bottle neck.

According to one embodiment, the fork is obtained by cutting it from a flat blank. Stainless steel or any material compatible with hygienically safe food preparation processes can typically be used. The thickness of the material can be between 2 and 5 mm; it can be adapted to optimize retention by the neck between the collar 70 and the flaring denoted 74.

In a top view, the receiving space 63 appears as a recess with withdrawal-preventing constriction, meaning in the illustrated example a constriction of width D5, D5 being slightly less than the diameter D6.

Each fork is fixed on the chain of the endless conveyor by means of holes 64 and screwing attachment or by any other means.

Illustrated in FIG. 5 is a double fork, i.e. a fork with two positions each having a different dimension, so as to be able to accommodate either large necks or small necks in the same handling device.

FIG. 4 illustrates the fact that the shape of the body of the bottle is immaterial to the gripping means and the neck; therefore we can have bottle bodies of all shapes and sizes (for example, a short bottle 7 and a long bottle 7′ in the illustration).

The bottle can be kept upright, meaning with the opening facing upwards, but also “upside down”, meaning with the opening facing downwards. Generally, the bottle can be held in any spatial orientation. Note that on the end portions of the buffer conveyor 2, the bottles are in a position with a horizontal axis A. It should be noted, however, that there can be some deviation between the theoretical axis corresponding to that of the housing of the fork and the actual axis of the bottle which is held in said housing.

Illustrated in FIG. 6 is a plate 66 forming a group of forks, assembled as that number of individual forks (here 4) or formed as an integral plate having that number of receiving housings (here 4).

Advantageously, for the second section T22 of the buffer conveyor 2, its bottle storage capacity is denoted N22,

N22 being dimensioned to satisfy the following condition:

N22>N8+N1−N4−1

In other words, the bottle storage capacity of the second section is at least equal to the number of bottles and preforms that can be received in the blowing machine 1 including in the heating tunnel 8, minus the number of bottles N4 that can be received in the upstream handling device.

For example, in the example of FIGS. 9A-9C, the storage capacity is 30 spaces. For example, in the example of FIG. 8, the storage capacity is greater than 60 spaces. Of course, higher or lower capacities can be targeted.

According to the invention, this avoids having to scrap the pieces which were in the heating tunnel and in the blowing device. Thus, the bottle storage capacity N22 for the second section T22 is at least equal to the number of bottles and preforms that can be received in the blowing machine 1 and in the heating tunnel 8, minus the number of bottles N4 that can be received in the upstream handling device.

Concerning the transfer devices 4 and 5, with reference to FIG. 7, for traveling from one endless conveyor to another a station may be provided, with forks which are located opposite the openings positioned facing one another. In the example shown, the bottles are transferred from conveyor C1 to conveyor C2.

The transfer can be done individually, bottle by bottle, or by batch. Here the transfer is a simple translational movement which can be caused by pushing the bottle from conveyor C1 to conveyor C2. Preferably, a bottle-transfer action is exerted on the neck portion, which makes it possible to have a solution independent of the shape and/or capacity of the body of the bottles.

In other embodiment(s), more sophisticated means such as a manipulator arm or a multi-axis robot may be used.

In a line configuration as schematically shown in FIG. 2, transfer devices with simple translational movement as illustrated above can be used for both loading the buffer conveyor and unloading the buffer conveyor.

The second transfer device, in charge of unloading the bottles from the buffer conveyor in order to load them onto the finishing line conveyor, can be controlled by a control unit, configured to activate or not activate the transfer device 5 according to the line operating conditions.

In particular, if for some reason the filling line 3 stops, then as a result the control unit will stop the operation of the second transfer device 5 so that the buffer conveyor continues to accept the arrival of empty bottles from the blowing device in order to accumulate them in the second section T22. When the second transfer device is inactive (stopped), the empty bottles then travel in front of the second transfer device without any transfer.

As soon as the filling line is back in operation, the control unit reactivates the second transfer device, then the bottles in the buffer conveyor can be emptied in FIFO mode while the blowing device is returned to service.

FIG. 12 illustrates a variant of the solution for holding the bottles in the endless conveyor. Movable jaw clamps are used. A clamp 16 comprises two jaws 16a, 16b. A spring for returning to the closed position is provided. Conversely, cam tracks and a mechanism to open the clamp under certain conditions of advancement of the clamp relative to the station are provided. The clamp in question can thus be used indiscriminately to grip small necks 78 or larger necks 79.

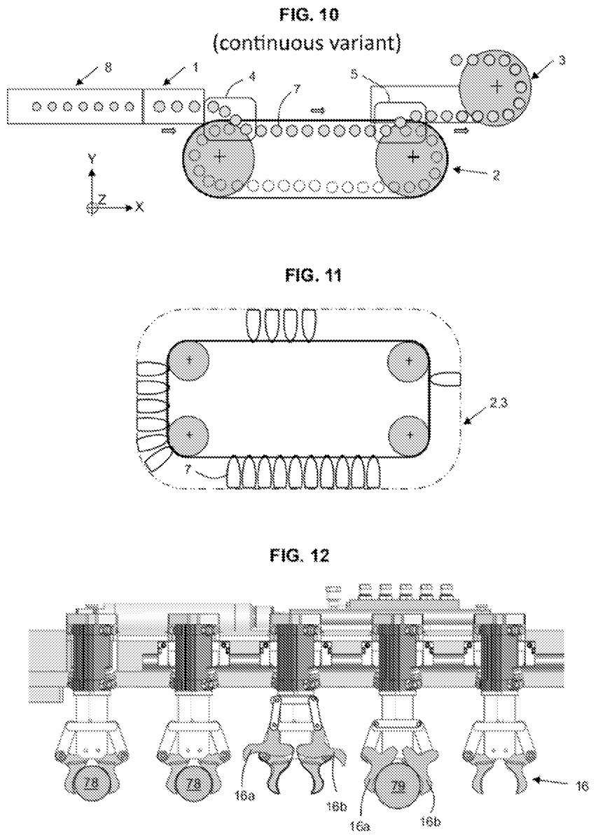

### Second Embodiment, FIG. 10

In this mode, schematically represented in FIG. 10, the facility operates with continuous kinematics, the blowing is with continuous kinematics, the handling is also with continuous kinematics, and the filling line is also with continuous kinematics in the form of a carousel.

Here, the buffer conveyor has been represented in a flat configuration, but of course, the buffer conveyor can be arranged in a vertical configuration as previously explained. It is thus possible to obtain very large production capacities.

Hybrid configurations are also possible, with part of the facility operating with continuous kinematics and another part operating with indexed kinematics.

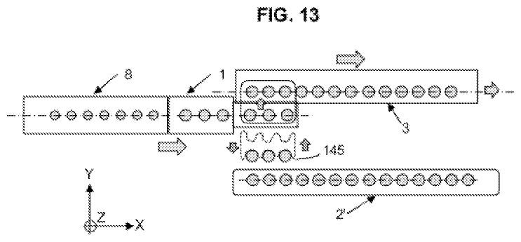

### Third Embodiment, FIG. 13

Here, the buffer conveyor 2 is operatively arranged between the blowing device 1 and the filling and finishing line 3, in a parallel configuration and not with series interposition as described above.

An upstream handling device 145 is provided, interposed between the blowing device 1 and the buffer conveyor 2, for loading and unloading bottles in the buffer conveyor 2. Here too, the buffer conveyor 2 being formed mainly as an endless conveyor, the entirety of the buffer conveyor serves as buffer storage space for conditions of unplanned stoppage of the filling line, without any first or second section as above.

The bottle storage capacity of the buffer conveyor, denoted N2, is dimensioned to satisfy the condition: N2>N8+N1−1.

As before, N8 denotes the number of bottles and preforms that can be received in the heating tunnel and N1 denotes the number of bottles and preforms that can be received in the blowing device.

According to the second and third embodiment, this avoids scrapping the pieces which were located in the heating tunnel and in the blowing device. The bottle storage capacity N2 for the buffer conveyor 2′ is thus at least equal to the number of bottles and preforms which can be received in the blowing machine 1 and in the heating tunnel 8.

The upstream handling device 145 can operate in normal flow mode, in which the buffer conveyor is not involved, or in a bypass/storage mode in which it loads into the buffer conveyor the bottles coming from the blowing device.

The buffer conveyor may be arranged in a vertical configuration or in a horizontal configuration, as already mentioned in the above cases.

1. A facility for the production of bottles of liquid or semi-liquid products, the bottles being formed from thermoformable plastic, the facility comprising:
a blowing device for blowing bottles from preforms, with a heating tunnel,
a filling and finishing line, comprising one or more bottle filling, sealing, and/or capping stations, the line comprising an endless conveyor capable of receiving empty bottles ready to be filled and conveying the bottles in front of several filling, sealing, and/or capping stations, wherein a buffer conveyor interposed between the blowing device and the filling and finishing line is provided, formed mainly as an endless conveyor suitable for receiving bottles, the buffer conveyor comprising a first section used under normal flow conditions, and a second section complementary to the first section and serving as a buffer storage space under conditions of unplanned stoppage of the filling line,
with an upstream handling device interposed between the blowing device and the buffer conveyor, having a number N4 of locations for bottles,
and wherein the bottle storage capacity of the second section (T22), denoted N22, is dimensioned to satisfy the condition N22>N8+N1−N4−1, where
N8 designates the number of bottles and preforms that can be received in the heating tunnel and N1 designates the number of bottles and preforms that can be received in the blowing device.

2. The facility according to claim 1, wherein the buffer conveyor operates with indexed kinematics, meaning with stationary operation after advancement.

3. The facility according to claim 1, wherein the bottle blowing device operates with indexed kinematics, meaning with stationary operation after advancement.

4. The facility according to claim 1, wherein the filling and finishing line operates with indexed kinematics with stationary filling.

5. The facility according to claim 1, wherein the upstream handling device comprises a first transfer device for loading the bottles arriving from the blowing device onto the buffer conveyor.

6. The facility according to claim 1, wherein a second transfer device is provided for unloading the bottles from the buffer conveyor and loading them onto the filling and finishing line.

7. The facility according to claim 1, wherein the bottles are held by the neck.

8. The facility according to claim 1, wherein each bottle is held by a fork.

9. The facility according to claim 1, wherein each bottle is held by a clamp.

10. The facility according to claim 1, wherein the buffer conveyor comprises a chain forming the support of the conveyor, and a plurality of forks, the forks being fixed on the chain, individually or in groups on a plate.

11. The facility according to claim 10, wherein the chain is mounted and wound on two or four wheels, said wheels each having a horizontal axis of rotation.

12. The facility according to claim 1, wherein the filling and finishing line operates with indexed kinematics with stationary filling, in batch production with batches of size N3.

13. The facility according to claim 1, wherein the bottles are held exclusively by the neck.

14. The facility according to claim 13, wherein the facility never places the bottles on the bottoms of the bottles.

15. The facility according to claim 2, wherein the bottle blowing device operates with indexed kinematics, meaning with stationary operation after advancement.

16. The facility according to claim 2, wherein the filling and finishing line operates with indexed kinematics with stationary filling.

17. The facility according to claim 3, wherein the filling and finishing line operates with indexed kinematics with stationary filling.

18. The facility according to claim 2, wherein the upstream handling device comprises a first transfer device for loading the bottles arriving from the blowing device onto the buffer conveyor.

19. The facility according to claim 3, wherein the upstream handling device comprises a first transfer device for loading the bottles arriving from the blowing device onto the buffer conveyor.

20. The facility according to claim 4, wherein the upstream handling device comprises a first transfer device for loading the bottles arriving from the blowing device onto the buffer conveyor.
